(19) United States
(12) Patent Application Publication
(10) Pub. No.: US 2026/0184010 A1
(43) Pub. Date: Jul. 2, 2026

(54) SUSTAINABLE UPCYCLING TOPOLOGICAL ARTIFICIAL REEF RESTORATION METHOD

(71) Applicant: TEAM ORZ LIMITED, Hong Kong (CN)

(72) Inventors: Tak Keung CHAN, Hong Kong (CN); Tsz Kin LEE, Hong Kong (CN)

(21) Appl. No.: 19/345,392

(22) Filed: Sep. 30, 2025

Related U.S. Application Data
(60) Provisional application No. 63/703,915, filed on Oct. 5, 2024.

(51) Int. Cl. B29C 64/118; A01K 61/73; B29C 64/314; B29K 67/00; B29K 509/02; B29L 31/10; B33Y 10/00; B33Y 40/10; B33Y 70/10; B33Y 80/00

(52) U.S. Cl. CPC B29C 64/118; A01K 61/73; B29C 64/314; B33Y 10/00; B33Y 40/10; B33Y 70/10; B33Y 80/00; B29K 2067/04; B29K 2509/02; B29L 2031/10

(57) ABSTRACT

comprises the following steps: S1. Pretreatment of seashells: Collect, sterilize and crush seashells to reach 2,500 meshes. S2. Preparation of 3D printing materials: Mix polyhydroxyalkanoate and additives with the calcium carbonate powder obtained in S1, and prepare 3D printing wires using an extruding machine. S3. Preparation of 3D printed artificial reef: Use the 3D printing wires to print artificial reef modules with a topological shape. S4. Installation of artificial reefs: Fix and connect the printed artificial reef modules to each other, and fix them according to different occasions, for example, fix in form of floating reefs or on benthal terrain. The invention enables efficient, environmentally friendly and customizable restoration of marine habitats. The method offers advantages such as material sustainability, topologically optimized structures that enhance water flow through artificial reefs, flexible installation, substantial ecological benefits, and lightweight artificial reefs that facilitate transportation.

### TECHNICAL FIELD

The invention relates to the technical field of artificial reef restoration, particularly to a sustainable upcycling topological artificial reef restoration method.

### BACKGROUND ART

The objective of this project is to develop and expand a comprehensive artificial reef (AR) restoration program, with a focus on utilizing upcycled seashells to create artificial oyster reefs. The method involves strategically arranging shells to mimic natural reef structures, with objectives including habitat restoration, biodiversity enhancement, and the creation of socio-economic benefits for local communities. Through ecological remediation, the project aims to improve marine ecosystem health, enhance water quality via oyster filtration, and safeguard coastlines against erosion and storm damage. It emphasizes a harmonious relationship between human activities and marine ecosystems, promoting sustainability and resilience in coastal environments.

Traditional artificial reefs are often made of concrete materials, which poses challenges including excessive weight, low installation efficiency, high transportation costs, difficulty in installation as floating reefs, and poor ecological compatibility. Natural oyster reefs regenerate slowly and are susceptible to environmental pollution. Although existing 3D-printed marine materials have made some progress, their sustainability, biodegradability in natural environments, structural adaptability, and ecological benefits still require further improvement.

### SUMMARY OF THE INVENTION

The invention provides a sustainable upcycling topological artificial reef restoration method, addressing issues such as lack of sustainability, absence of topologically optimized structural design, low installation efficiency and poor ecological compatibility in existing artificial reefs through technological transformation.

To achieve the above-mentioned objectives, the invention adopts the following technical proposal:

A sustainable upcycling topological artificial reef restoration method, comprising the following steps:
S1. Pretreatment of seashells: Collect, sterilize and crush seashells to reach 2,500 meshes.
S2. Preparation of 3D printing materials: Mix polyhydroxyalkanoate and additives with the calcium carbonate powder obtained in S1, and prepare 3D printing wires using an extruding machine.
S3. Preparation of 3D printed artificial reef: Use the 3D printing wires to print artificial reef modules with a topological shape.
S4. Installation of artificial reefs: Fix and connect the printed artificial reef modules to each other, and select either rock mode or installation mode for fixation according to the benthal terrain. The rock mode refers to the floating reef installation method, while the installation mode refers to a fixed installation method.

Preferably, S1 also comprises the following steps:
S101: Boiling: Place the cleaned seashells into boiling water and boil for 30 minutes at a sterilization temperature of 100° C.

S102: Cleaning: Gently scrub the seashells with a brush or sponge to remove sand, dirt and surface attachments.

Preferably, the seashells used in S1 are selected from at least one of oyster shells or other shellfish shells.

Preferably, S2 also comprises the following steps:
S201: Mixing: Mix the calcium carbonate powder obtained in S1 with the following component ratio: 80% of polyhydroxyalkanoate, 19.5% of calcium carbonate powder, 0.2% of pentaerythritol, 0.1% of L-alanine, and 0.2% of aliphatic ester.

S202: Wire preparation: Extrude the mixture prepared in S201 through the extruding machine to prepare filamentous wires with a diameter of 2.5 to 3 mm.

S203: Cutting: Cut the filamentous wires prepared in S202 into granules for use in a granule-based 3D printer; execute S204 when long filamentous wires are required.

S204: Preparation of filamentous wires: Place the granules back into the extruding machine and then prepare them into filaments with a diameter of 1.75 mm for use in an FDM 3D printer.

Preferably, in S3, the printing temperature is 190-210° C., the printing layer thickness is 0.2 mm, and the printing speed is 50 mm/s.

Preferably, the topological shape comprises a groove with a depth of 0.5-2 mm and a width of 400-700μm to facilitate the attachment of marine larvae.

Preferably, the rock mode in S4 is suitable for irregular benthal terrains or floating reefs, while the installation mode is suitable for flat benthal terrains.

The invention has the following benefits:

The precise combination is essential for ensuring optimal structural integrity and performance of the wires. Incorporating calcium carbonate into the wires enhances the performance of the present application in the printed artificial reef material, improving both its strength and durability. This formulation ensures that the wires can withstand the demands of the 3D printing process while maintaining consistent performance and strong stability during use. The low calcium carbonate content in the formulation ensures uniform wire composition, providing reliable and reproducible printing results across diverse applications and environmental conditions.

The present application achieves efficient, customized and eco-friendly deployment of artificial reefs by converting seashells into calcium carbonate fillers, combining them with PHA bio-based materials and 3D-printing them into artificial reef modules with ecologically adapted topological shapes. The method offers advantages such as material sustainability, topologically optimized structures that enhance water flow through artificial reefs, flexible installation, significant ecological benefits, and lightweight artificial reefs that facilitate transportation.

### BRIEF DESCRIPTION OF THE DRAWINGS

FIG. 1 is a schematic diagram of the actual materials used in the 3D printing wire preparation process of the invention.

FIG. 2 is an installation diagram of the artificial reef module of the invention in both the installation mode and the rock mode.

FIG. 3 is a schematic diagram of the interconnection state of the artificial reef modules of the invention.

FIG. 4 is a schematic diagram of the water flow energy curve after the installation of the artificial reef module of the invention.

FIG. 5 is a schematic diagram of the groove position for the artificial reef module of the invention.

FIG. 6 is an installation diagram of the artificial reef module of the pillar oyster reef of the invention.

FIG. 7 is a flow diagram of the artificial reef restoration method of the invention.

Reference signs: 3D printing wire 101, polyhydroxyalkanoate material 102, calcium carbonate material 103, shell 104, shredded shell 105, sterilization treatment material 106, artificial reef module 201, mounting hole 202, topological shape 203, groove 204, rock mode 301, and installation mode 302.

### DETAILED DESCRIPTION OF THE INVENTION

The invention will be elaborated in detail below with reference to the drawings and embodiments.

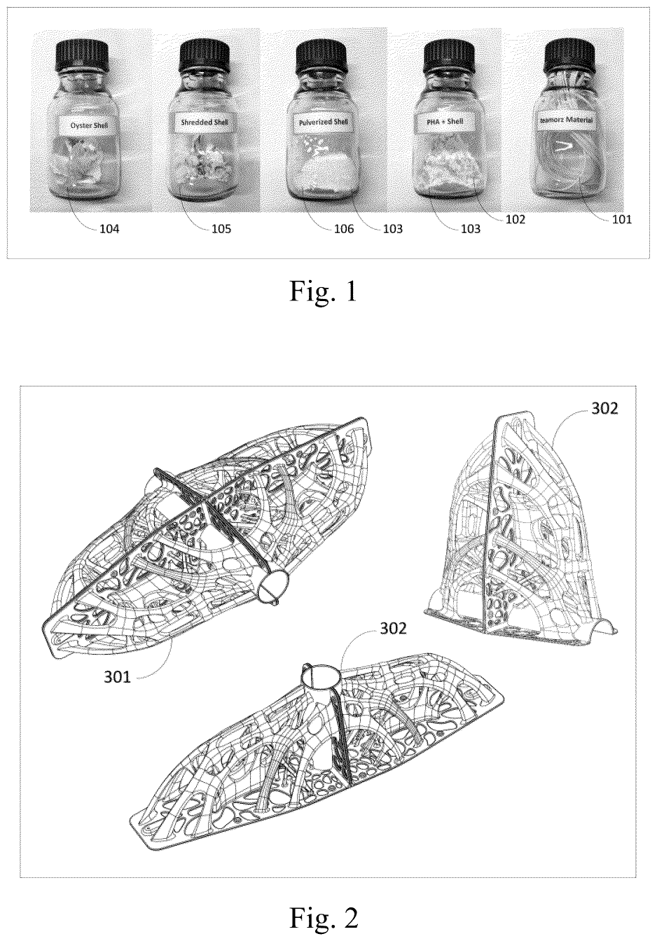

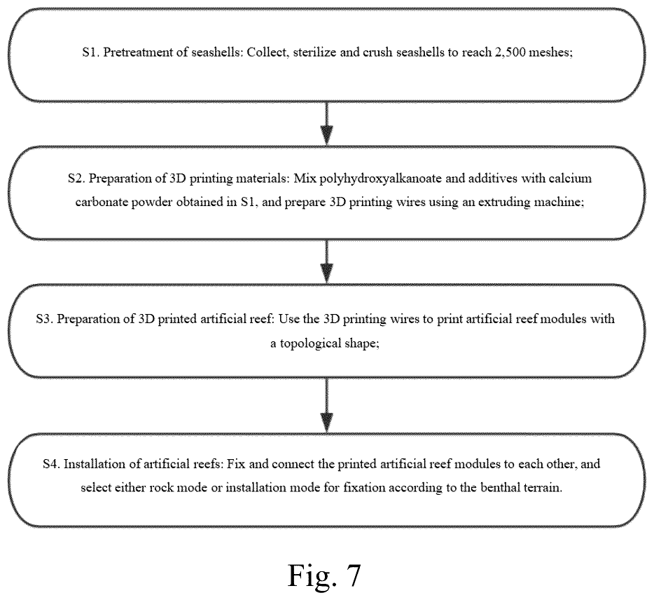

As shown in FIGS. 1-7, the invention provides a sustainable upcycling topological artificial reef restoration method, comprising the following steps:
S1. Pretreatment of seashells: Collect, sterilize and crush seashells 104 to reach 2,500 meshes.
S101: Boiling: Place the cleaned seashells 104 in boiling water and boil for 30 minutes at a sterilization temperature of 100° C.
S102: Cleaning: Gently scrub the seashells 104 with a brush or sponge to remove sand, dirt and surface attachments.
S2. Preparation of 3D printing materials: Mix polyhydroxyalkanoate and additives with the calcium carbonate powder obtained in S1, and prepare 3D printing wires 101 using an extruding machine.
S3. Preparation of 3D printed artificial reef: Use the 3D printing wires 101 to print artificial reef modules with a topological shape 203.
S4. Installation of artificial reefs: Fix and connect the printed artificial reef modules 201 to each other, and select either rock mode 301 or installation mode 302 for fixation according to the benthal terrain. Rock mode refers to the floating reef installation method, while installation mode refers to fixed installation method.

Further, the calcium carbonate used in the present application is derived from the seashells 104, such as oyster shells, shellfish shells and similar sources.

Further, S2 comprises the following steps:
S201: Mixing: Mix the calcium carbonate powder obtained in S1 with the following component ratio: 80% of polyhydroxyalkanoate, 19.5% of calcium carbonate powder, 0.2% of pentaerythritol, 0.1% of L-alanine, and 0.2% of aliphatic ester.

S202: Wire preparation: Extrude the mixture prepared in S201 using an extruding machine to prepare filamentous wires with a diameter ranging from 2.5 to 3 mm.

S203: Cutting: Cut the filamentous wires prepared in S202 granules suitable for 3D printing in a granule-based 3D printer for granules; execute S204 when long filamentous wires are required.

S204: Preparation of filamentous wires: Place the granules back into the extruding machine and then process them into filaments with a diameter of 1.75 mm for use in an FDM 3D printer.

FIG. 1 shows seashells 104, crushed shells 105, sterilized calcium carbonate powder 103 using sterilization treatment material 106, a mixture of calcium carbonate material 103 and polyhydroxyalkanoate material 102, and 3D printing wires 101.

Further, in S3, an FDM 3D printer is used to print and prepare the artificial reef module 201 with the topological shape 203 at a printing temperature of 190-210° C., a printing layer thickness of 0.2 mm and a printing speed of 50 mm/s.

The present application adopts the topological method to design the model. The printed artificial reef module 201 is designed to simulate the natural reef structure and has a topological shape 203, thereby promoting the optimum ecological effect and the restoration of marine habitats.

Further, as shown in FIG. 2, in S4, the rock mode 301 is suitable for irregular benthal terrains, whereas the installation mode is suitable for flat benthal terrains.

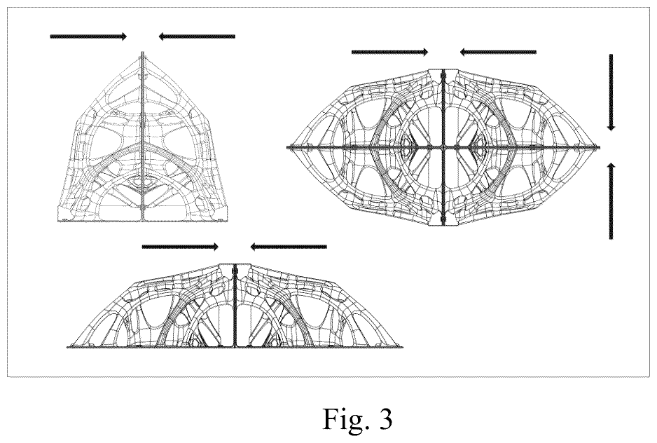

As shown in FIG. 3, the artificial reef module 201 of the present application adopts a modular structure and is securely fastened with screws 316, allowing for multi-functional installation on various surfaces.

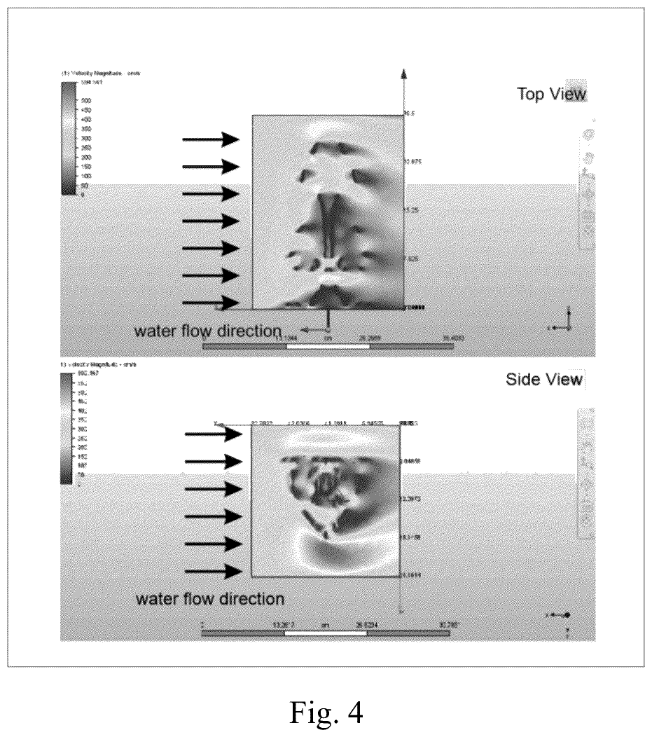

As shown in FIG. 4, the topological shape 203 adopted in the present application offers multiple advantages. By promoting water flow while attenuating wave energy, the method creates a favorable environment for the growth of oysters and various marine organisms and achieves higher wave energy attenuation rate compared to traditional concrete reefs.

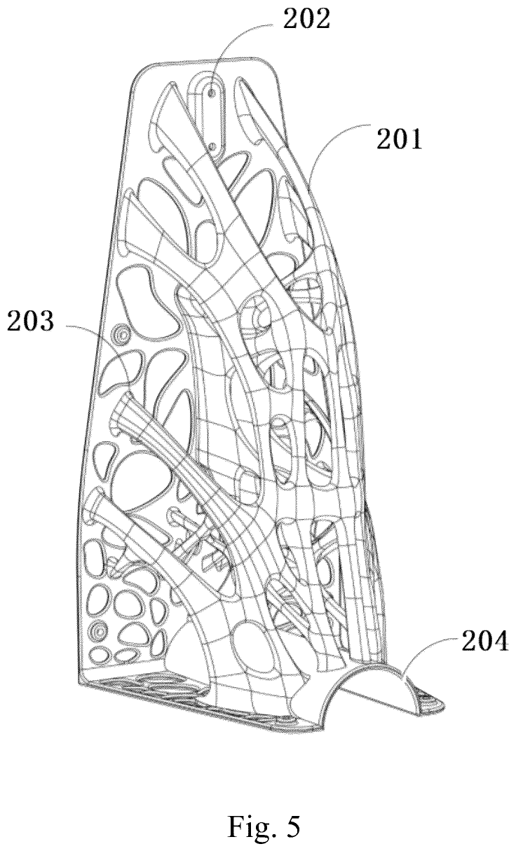

Further, as shown in FIG. 5, the artificial reef module 201 is equipped with mounting holes 202, whose uses include but are not limited to connecting the artificial reef module and facilitating the attachment of monitoring equipment to the artificial reef module 201.

Further, the artificial reef module comprises grooves 204 with a depth of 0.5-2 mm and a width of 400-700 μm. The present application incorporates grooves 204 of different widths, as shown in FIG. 5, increasing the surface area of the artificial reef module to promote the attachment of Marine larvae, thereby optimizing its effectiveness and ecological impact.

The artificial reef module 201 designed in the present application can also be installed on a large scale according to traditional artificial reef restoration methods to accelerate the installation of large-scale artificial reefs.

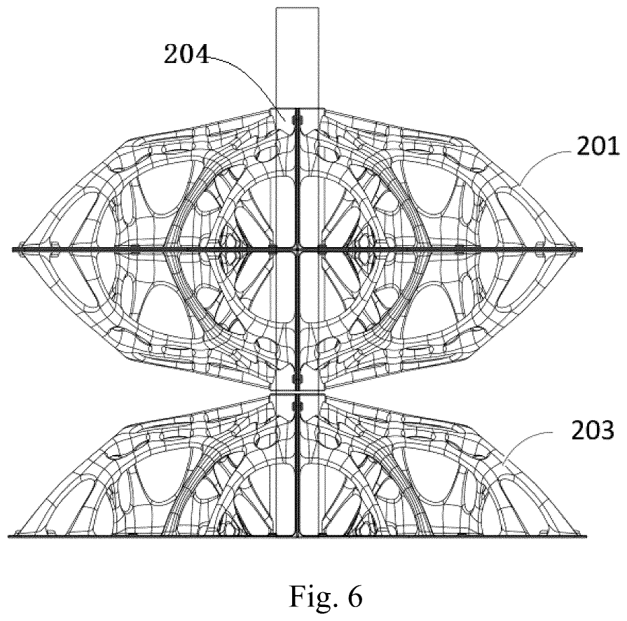

As shown in FIG. 6, the present application also provides an installation method for the artificial reef module 201 for pillar oyster reefs.

The materials selected for the present application not only promote oyster growth but also support environmental sustainability through their combined use. Furthermore, they provide sufficient nutrients for microorganisms, accelerate the artificial reef restoration process, and stimulate the development of biofilms and biomass.

The extensive surface area inherent of this unique shape acts as a catalyst for biomass accumulation, thereby enhancing the ecological efficacy of the artificial reef structure and contributing to the overall sustainability of the marine ecosystem.

The topological shape 203 in the present application can be fabricated using a household 3D printer, ensuring accessibility and ease of production. Additionally, the structure of the present application requires no additional support structure during printing, thereby streamlining the manufacturing process and minimizing material waste.

Field installation experiments to verify the ecological effect:

After six months of implementation, the oyster attachment rate increased by 35%, the water turbidity decreased by 20%, the total nitrogen and phosphorus content decreased by 15%, and the regional biodiversity significantly increased.

The PHA-calcium carbonate composite material prepared in the present application is expected to degrade over a 3 to 5 years cycle in seawater environment, with degradation products that are harmless to the environment.

The precise combination is essential to ensure optimal structural integrity and performance of the wires. By adding calcium carbonate to the wires, the present application enhances the performance of the printed artificial reef material, improving both higher strength and durability. This formulation ensures that the wires can withstand the demands of the 3D printing process while maintaining consistent performance and strong stability during use. The low calcium carbonate content in the formulation ensures uniform wire composition, thereby providing reliable and reproducible printing results across diverse applications and environmental conditions.

The present application achieves efficient, customized and eco-friendly deployment of artificial reefs by converting seashells into calcium carbonate fillers, combining them with PHA bio-based materials and 3D-printing them into artificial reef modules with ecologically adapted topological shapes. The method offers advantages such as material sustainability, topologically optimized structures that enhance water flow through artificial reefs, flexible installation, notable ecological benefits, and lightweight artificial reefs that facilitate transportation.

Finally, it should be noted that the above embodiments are intended only to describe the technical proposals of the invention and do not serve to limit them. Although the invention has been described in detail with reference to the preferred embodiments, those skilled in the art should understand that modifications or equivalent replacements to the technical proposals of the invention may be made without departing from the purpose and scope of the technical proposals of the invention. Such modifications or equivalent replacements should be covered within the scope of the claims of the invention.

Standard parts used in the invention can be purchased from the market, while special-shaped parts can be custom-made according to the specification and the drawings. All parts are joined using conventional methods such as bolts, rivets and welding, which are mature techniques in the prior art. Machines, parts and equipment are of conventional models known in the prior art, and circuit connections are implemented using conventional methods in the prior art. These will not be described in detail here.

In the description of the invention, unless otherwise explicitly specified and defined, the terms “installed”, “connected”, “coupled” and “fixed” should be interpreted in a broad sense. For example, connections may be fixed, detachable or integral connections; they may be mechanical or electrical connections; they may be direct connections or achieved through an intermediate medium; they may be internal connections or interaction relationships between two elements. Those skilled in the art will understand the specific meanings of these terms in the context of the invention as the case may be.

1. A sustainable upcycling topological artificial reef restoration method, comprising the following steps:
S1. Pretreatment of seashells: Collect, sterilize and crush seashells to reach 2,500 meshes;
S2. Preparation of 3D printing materials: Mix polyhydroxyalkanoate and additives with calcium carbonate powder obtained in S1, and prepare 3D printing wires using an extruding machine;
S3. Preparation of 3D printed artificial reef: Use the 3D printing wires to print artificial reef modules with a topological shape;
S4. Installation of artificial reefs: Fix and connect the printed artificial reef modules to each other, and select either rock mode or installation mode for fixation according to the benthal terrain; wherein rock mode refers to the floating reef installation method, and installation mode refers to fixed installation method.

2. The sustainable upcycling topological artificial reef restoration method according to claim 1, wherein S1 also comprises the following steps:
S101: Boiling: Place the cleaned seashells into boiling water and boil for 30 minutes at a sterilization temperature of 100° C.;
S102: Cleaning: Gently scrub the seashells with a brush or sponge to remove sand, dirt and surface attachments.

3. The sustainable upcycling topological artificial reef restoration method according to claim 1, wherein the seashells in S1 are selected from at least one of oyster shells or shellfish shells.

4. The sustainable upcycling topological artificial reef restoration method according to claim 1, wherein S2 also comprises the following steps:
S201: Mixing: Mix the calcium carbonate powder obtained in S1 by the following component ratio: 80% of polyhydroxyalkanoate, 19.5% of calcium carbonate powder, 0.2% of pentaerythritol, 0.1% of L-alanine, and 0.2% of aliphatic ester;
S202: Wire preparation: Extrude the mixture prepared in S201 through the extruding machine to prepare filamentous wires with a diameter of 2.5 to 3 mm;
S203: Cutting: Cut the filamentous wires prepared in S202 into granules for use in a granule-based 3D printer; execute S204 when filamentous wires are required;
S204: Preparation of filamentous wires: Place the granules back into the extruding machine and then prepare them into filaments with a diameter of 1.75 mm for use in an FDM 3D printer.

5. The sustainable upcycling topological artificial reef restoration method according to claim 1, wherein in S3, the printing temperature is 190-210° C., the printing layer thickness is 0.2 mm, and the printing speed is 50 mm/s.

6. The sustainable upcycling topological artificial reef restoration method according to claim 1, wherein the topological shape in S3 comprises a groove with a depth of 0.5-2 mm and a width of 400-700μm to facilitate the attachment of marine larvae.

7. The sustainable upcycling topological artificial reef restoration method according to claim 1, wherein the rock mode in S4 is suitable for irregular benthal terrains or floating reefs, and the installation mode is suitable for flat benthal terrains.
